(19) United States
(12) Patent Application Publication
(10) Pub. No.: US 2019/0148955 A1
(43) Pub. Date: May 16, 2019

(54) POWER SUPPLY DEVICE AND POWER SUPPLY METHOD

(71) Applicant: SONY CORPORATION, TOKYO (JP)

(72) Inventor: TAKUYA TAKENAKA, KANAGAWA (JP)

(21) Appl. No.: 16/098,144

(22) PCT Filed: Mar. 28, 2017
(86) PCT No.: PCT/JP2017/012671

§ 371 Date: Nov. 1, 2018

(30) Foreign Application Priority Data
May 13, 2016 (JP) 2016-096689

(51) Int. Cl. H02J 7/00; G06F 1/28

(52) U.S. Cl. CPC H02J 7/0021; G06F 1/28

(57) ABSTRACT

A power supply device including: a boosting circuit that boosts power supplied from a power source to a target voltage based on a voltage of a secondary battery capable of supplying power to a load, and supplies the boosted power to the load.

### TECHNICAL FIELD

The present technology relates to a power supply device and a power supply method.

### BACKGROUND ART

In the past, a secondary battery charging device including a boosting unit that boosts an input voltage to a charging voltage necessary to charge a secondary battery has been proposed (Patent Literature 1).

### CITATION LIST

### Patent Literature

Patent Literature 1: JP 2004-288537A

### DISCLOSURE OF INVENTION

### Technical Problem

In a device that is provided with such a boosting unit and that supplies power using a battery, ordinarily voltage is first boosted by the boosting unit, regardless of the voltage required by the load side receiving the supply of power, and then stepped down to the voltage required by the load. Therefore, power loss due to the change in voltage may occur when the voltage is boosted and when the voltage is stepped down.

In view of such circumstances, it is an object of the present technology to provide a power supply device and a power supply method capable of reducing power loss caused by boosting the voltage.

### Solution to Problem

To solve the problem described above, a first technique is a power supply device including: a boosting circuit that boosts power supplied from a power source to a target voltage based on a voltage of a secondary battery capable of supplying power to a load, and supplies the boosted power to the load.

In addition, a second technique is a power supply method including: boosting power supplied from a power source to a target voltage based on a voltage of a secondary battery capable of supplying power to a load, and supplying the boosted power to the load.

### Advantageous Effects of Invention

According to the present technology, power loss caused by boosting the voltage can be reduced. Note that the effects described here are not necessarily limited and may be any of the effects described in the specification.

### BRIEF DESCRIPTION OF DRAWINGS

FIG. 1 is block diagram illustrating a configuration of a power supply device according to the present technology.

FIG. 2 is a graph illustrating discharge characteristics of a secondary battery.

FIG. 3 is a graph explaining initial charging and fast charging.

FIG. 4 is a graph explaining battery voltage, boost lower limit voltage, and boost upper limit voltage.

FIG. 5 is a graph explaining battery voltage and target voltage.

FIG. 6 is a view explaining a voltage change due to fluctuation in the power consumption of a load.

FIG. 7 is a graph explaining battery voltage, boost lower limit voltage, and power loss.

### MODE(S) FOR CARRYING OUT THE INVENTION

Hereinafter, modes for carrying out the present technology will be described with reference to the accompanying drawings. Note that the description will be given in the following order.

### <1. Embodiment>

[1-1. Configuration of power supply device]
[1-2. Power supply operation]
[1-2-1. Supplying power from power source to load]
[1-2-2. Supplying power from power source to secondary battery]
[1-2-3. Supplying power from secondary battery to load]
<2. Modified example>

### 1. Embodiment

[1-1. Configuration of Power Supply Device]

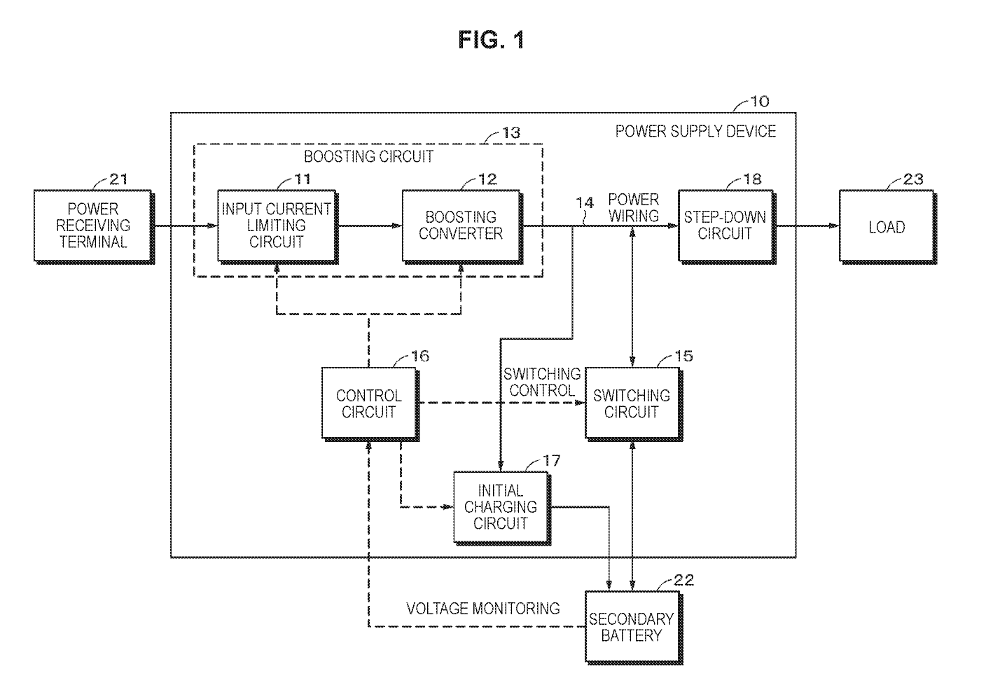

FIG. 1 is a block diagram illustrating a configuration of a power supply device 10 according to the present technology. The power supply device 10 includes a boosting circuit 13 that includes an input current limiting circuit 11 and a boosting converter 12, power wiring 14, a switching circuit 15, a control circuit 16, an initial charging circuit 17, and a step-down circuit 18. A power receiving terminal 21, a secondary battery 22, and a load 23 are connected to this power supply device 10. Note that in FIG. 1, the solid line connecting each of the blocks represents a power transmission line for transmitting power. Also, the broken line connecting each of the blocks represents a control line for transmitting a control signal.

The power receiving terminal 21 is connected to a power source such as a power system, and power from the power source is supplied to the power supply device 10 via the power receiving terminal 21. A universal serial bus (USB) Vbus is one example of the power receiving terminal 21. The USB Vbus is one of four signal lines of the USB, and is a power line that supplies +5 V of power. However, the power receiving terminal 21 is not limited to the USB Vbus, as long as it corresponds to a method of supplying power from a direct-current power supply input. Also, any power source may be used as long as it is necessary to boost the voltage in order to supply power to the load 23.

The power receiving terminal 21 is connected to the input current limiting circuit 11 of the boosting circuit 13, and power from the power source is supplied to the input current limiting circuit 11 via the power receiving terminal 21. The input current limiting circuit 11 is a circuit for controlling the amount of current supplied from the power source to the power supply device 10. In a case where the USB Vbus is used as the power receiving terminal 21, the input current limiting circuit 11 limits the current so as not to exceed an upper limit current value prescribed by the USB standard and then receives the power. As the input current limiting circuit 11, for example, an input current limiting circuit in which resistors for limiting the current are connected in series, a constant current circuit in which a transistor and a resistor are combined, or a constant current circuit in which a transistor, a resistor, and an operational amplifier are combined, or the like can be used.

The boosting converter 12 boosts the power supplied from the input current limiting circuit 11 toward a target voltage set as a boost target. The target voltage is a voltage that is higher than the current battery voltage of the secondary battery 22, and is a value equal to or less than a value (hereinafter, referred to as the multiplication voltage value) obtained by multiplying the maximum voltage per cell of secondary batteries connected in series in order to form the secondary battery 22, and the number of those secondary batteries that are connected in series. In a case where the secondary battery 22 includes two lithium-on secondary batteries that are connected together in series, the multiplication voltage value is 8.4 V, which is a value two times the maximum voltage of 4.2 V per cell of the lithium-ion secondary batteries.

In this way, the boosting circuit 13 can receive power so as not to exceed the upper limit current value prescribed by the standards and the like, by limiting the power from a power source such as a USB type alternating current (AC) adapter, or the host-side with respect to the USB Vbus, for example. If the power consumption of the load 23 exceeds the power supplied from the boosting circuit 13, the output voltage of the boosting circuit 13 will abruptly drop. Therefore, a circuit that does not require excessive power from the power supply side is realized by the boosting converter 12 operating while complying with the specified input current limit standard.

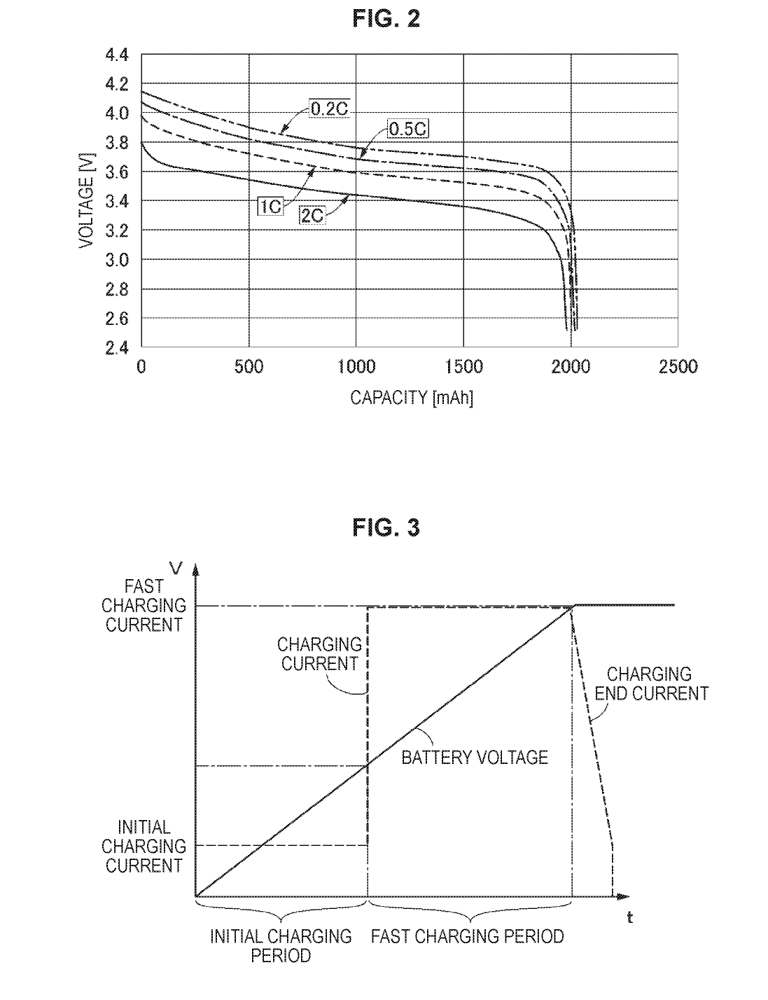

The secondary battery 22 in the present embodiment is formed by connecting two lithium-ion secondary batteries together in series. The secondary battery 22 is able to charge with power from a power source that is supplied from the boosting circuit 13, and is able to supply power to the load 23. The lithium-ion secondary batteries have a maximum voltage of 4.2 V per cell. As illustrated in FIG. 2, the lithium-ion secondary batteries have a discharge characteristic per cell in which a rated voltage of around 3.7 V is maintained for most of the discharge period. Because the two lithium-ion secondary batteries that are connected together in series have a characteristic in which the voltage is doubled, they likewise have a characteristic in which the voltage is maintained at a rated voltage of around 7.4 V.

The power boosted by the boosting converter 12 is supplied to the secondary battery 22 via the power wiring 14 and the switching circuit 15 or the initial charging circuit 17. The switching circuit 15 is formed using an ideal diode circuit, and is provided so as to be interposed between the power wiring 14 and the secondary battery 22. The switching circuit 15 switches between supplying power from the boosting circuit 13 to the secondary battery 22, and supplying power from the secondary battery 22 to the load 23 via the power wiring 14, under the control of the control circuit 16.

In the switching circuit 15, a forward bias as a diode is set in the direction from the secondary battery 22 toward the power wiring 14. In a case where the target voltage of the boosting circuit 13 is higher than the voltage of the secondary battery 22, a reverse bias is applied to the switching circuit 15 such that power will neither be supplied from the boosting circuit 13 to the secondary battery 22 via the power wiring 14 nor from the secondary battery 22 to the load 23 via the power wiring 14.

Also, in a case where the voltage of the power wiring 14 drops suddenly, if the voltage of the secondary battery 22 becomes higher than the voltage of the power wiring 14, a forward bias will be applied to the switching circuit 15 and power will start to be supplied from the secondary battery 22 to the load 23. As a result, the voltage of the power wiring 14 will not drop much below the voltage of the secondary battery 22, so operation of the load 23 can be normally maintained. According to such a configuration, operation of the load 23 can be kept normal while minimizing degradation of the secondary battery 22.

The control circuit 16 includes, for example, a microcomputer, a central processing unit (CPU), random access memory (RAM), and read only memory (ROM) and the like, and is connected to the boosting circuit 13, the secondary battery 22, the switching circuit 15, and the initial charging circuit 17. The control circuit 16 monitors the voltage value of the secondary battery 22 and notifies the boosting converter 12 of the boosting circuit 13, of this voltage value.

The boosting converter 12 sets a target voltage on the basis of the voltage of the secondary battery 22 notified by the control circuit 16, and boosts the voltage of the power supplied from the power source so that it comes to match this target voltage. However, the control circuit 16 may be configured to set the target voltage and control the operation of the boosting converter 12. Also, the control circuit 16 may set an input current limitation value of the input current limiting circuit 11 and control the operation of the input current limiting circuit 11. Further, the control circuit 16 may also perform switching control of the switching circuit 15.

Setting the target voltage in accordance with the voltage of the secondary battery 22 in this way can be realized by circuit in which the target voltage tracks the voltage of the secondary battery 22. Tracking refers to causing a given value to change so that it follows another value. A method of tracking by directly inputting a target voltage to a feedback circuit provided in the boosting converter 12 using an analog circuit and generating a reference voltage may be employed as the method of tracking. Also, using an external micro-controller, the boosting circuit 13 acquires information regarding discrete target voltage information using communicating means such as inter-integrated circuit (I2C), for example, on the basis of the voltage of the secondary battery 22 detected by an A/D converter of the micro-controller, and sets this information in a control register of the boosting circuit 13. Also, a method of tracking the voltage of the secondary battery 22 by setting this target voltage information as the target voltage may be adopted. The method for detecting the voltage of the secondary battery 22 that will serve as the reference voltage of the tracking voltage can be realized by inputting the voltage of electrical wiring in the vicinity of the secondary battery 22 to the feedback circuit of the boosting converter 12. Also, in a case where the reference voltage is determined using the external micro-controller, not only the method of detecting the voltage with the A/D converter of the micro-controller, but also a method of acquiring the reference voltage by communication between the secondary battery 22 and the control circuit 16 via a micro-controller built into the secondary battery 22, may be used.

Both of the two tracking methods described above may be employed, and tracking may be realized using either of these means. Also, both of these may be used simultaneously to set a more detailed target voltage and boost the voltage. In a case where such tracking is performed, the target voltage may be set using an instantaneous value as it is as the target voltage. Also, a time average value over a fixed period of time may be taken as the target voltage, and the target voltage may be set using this value. In the case of this method, the target voltage can be kept constant to some extent even if there is a large fluctuation in the voltage of the secondary battery 22, so the boosting circuit 13 can perform a more stable boost operation.

Note that the target voltage may be able to be set by selecting the value closest to the voltage of the secondary battery 22, from among a plurality of values set in advance.

In addition to supplying power to the load 23, the power supply device 10 can also charge the secondary battery 22. The initial charging circuit 17 is connected to the power wiring 14 and the secondary battery 22, and supplies the power supplied from the boosting circuit 13 to the secondary battery 22, as well as performs charging, referred to as initial charging, in which the charging current is suppressed to a constant small value, as illustrated in FIG. 3.

The initial charging circuit 17 is formed using a constant current circuit such as a low drop out (LDO) regulator to perform charging while suppressing the current. In a case where initial charging is performed and the charging voltage exceeds a predetermined threshold value for transitioning from initial charging to fast charging, the charging current value is made to change from an initial charging current value to a fast charging current value, and charging is made to continue so that charging will finish at a desired time.

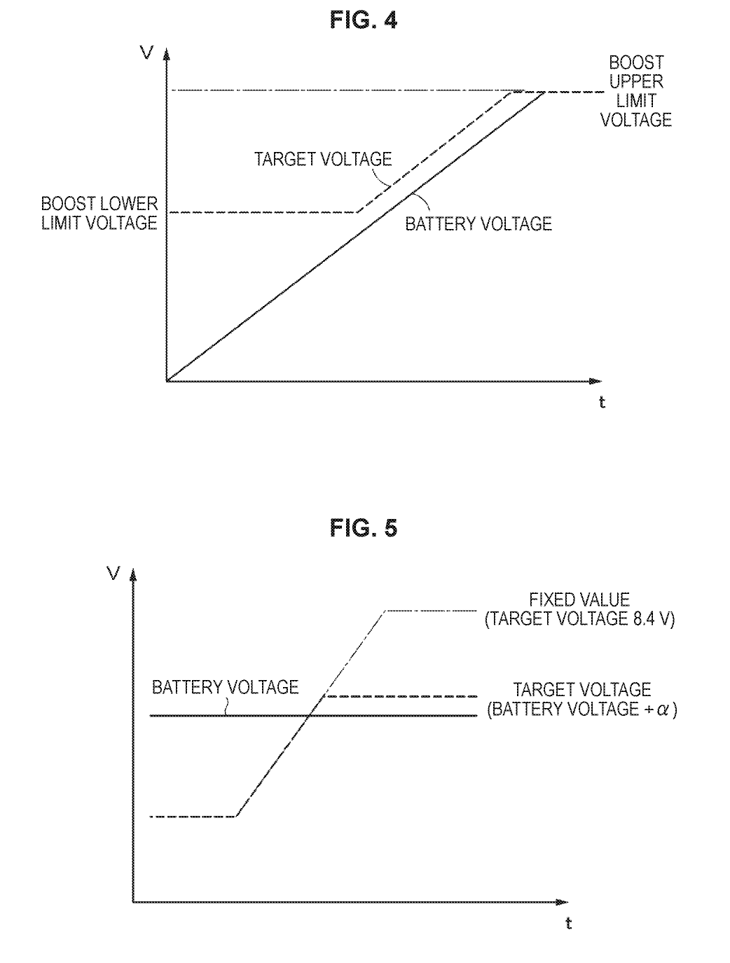

Although described later in detail, in the charging of the secondary battery 22 by the initial charging circuit 17, the boosting circuit 13 sets a boost lower limit (hereinafter, referred to as boost lower limit voltage) and a boost upper limit (hereinafter, referred to as boost upper limit voltage), which are values equal to or greater than the voltage of the secondary battery 22, as illustrated in FIG. 4. Also, during the period in which the initial charging circuit 17 performs the initial charging, the boosting circuit 13 boosts the supplied power up to the boost lower limit voltage. Further, in a case where charging has transitioned from initial charging to fast charging, the voltage of the supplied power is made to increase in proportion to the increase in the voltage of the secondary battery 22, and is finally boosted to the boost upper limit voltage that is equal to the voltage when the secondary battery 22 is fully charged.

When the charging voltage reaches a predetermined voltage, charging becomes constant voltage charging, and constant voltage charging in which the charging current flows depending on the impedance of the secondary battery 22. When constant voltage charging continues, the charging current uniformly decreases, and when the charging current becomes equal to or less than a certain threshold value, charging proceeds to completion. In charging, there is a current detection method in which charging is stopped immediately when it is detected that the charging current has become equal to or less than a threshold value, and a timer charging method in which charging is stopped after charging is continued for a certain period of time. Performing charging with such a charging flow enables the secondary battery 22 to be charged safely and optimally.

The description will now return to the power supply device 10 in FIG. 1. The step-down circuit 18 steps down the power from the secondary battery 22 or a power source that was supplied through the power wiring 14 to the voltage required by the load 23 and supplies the stepped-down power to the load 23. The step-down circuit 18 includes, for example, a switching regulator and a DC-DC converter and the like.

The load 23 is an electric device, an electronic device, or a component that forms an electric device or an electronic device, which consumes power supplied through the step-down circuit 18. A camera is an example of such a device. Also, an image stabilizing motor or a focusing motor for a camera is an example of a component. Note that the load 23 is not limited to such an electronic device, an electric device or a component that forms an electronic device, and may be anything that operates with power.

The power supply device 10 according to the present embodiment is configured as described above.

[1-2. Power Supply Operation] In a case where a secondary battery is formed by connecting two lithium-ion secondary batteries together in series in a conventional power supply device provided with a boosting circuit, a target voltage of the boosting circuit is boosted to a target voltage of 8.4 V which is a fixed value, regardless of the state of the step-down circuit or the required voltage of the load, as illustrated by the alternate long and short dash line in FIG. 5. This target voltage of 8.4 V is set as twice the maximum voltage of 4.2 V per cell of the lithium-ion secondary batteries. Then, when supplying power to a load, power is supplied after causing the voltage of the power to be stepped down to a voltage required by the load using a step-down circuit. Accordingly, in a case where a secondary battery includes two lithium-ion secondary batteries in series and the rated voltage is 7.4 V, power loss caused by once boosting the voltage up to 8.4 V, as well as power loss caused by stepping down the voltage from 8.4 V, occurs, and moreover, the temperature inside the power supply device ends up increasing due to the generation of heat.

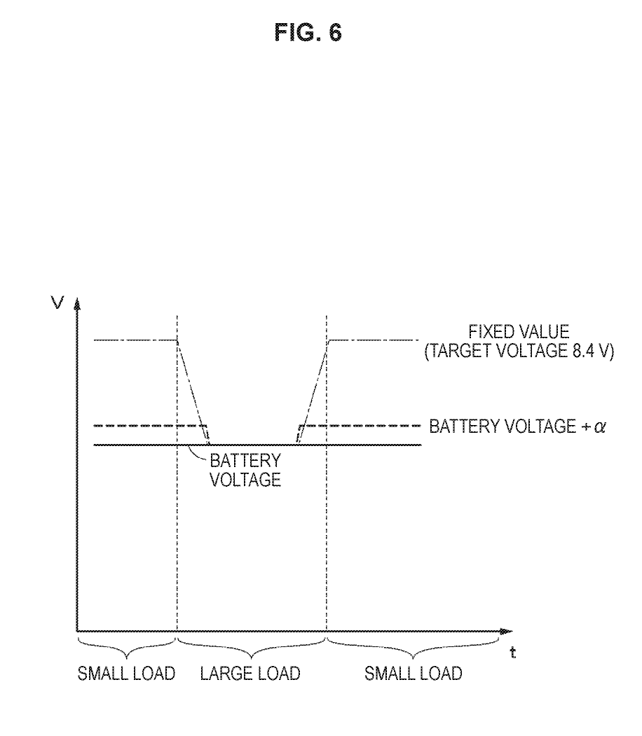

Also, in a case where the target voltage is fixed at 8.4 V, the voltage of the power wiring is maintained at 8.4 V in a case where the power consumed by the load is equal to or less the supply capability of the boosting circuit, as illustrated by the alternate long and short dash line in FIG. 6. However, in a case where the power consumed by the load exceeds the supply capability of the boosting circuit, a phenomenon in which the power drops to the battery voltage occurs, depending on the load fluctuation amount. Also, this voltage fluctuation may affect the operation of the load. For example, the output voltage of the step-down circuit will be affected in a case where the voltage fluctuation becomes larger than the voltage fluctuation allowed by the input voltage fluctuation characteristic of the step-down circuit connected to the downstream side of the power wiring.

[1-2-1. Supplying Power from Power Source to Load]

Supplying power to the load 23 by the power supply device 10 according to the present embodiment will be described. Note that in the present embodiment, a case where the secondary battery 22 is formed by connecting two lithium-ion secondary batteries together in series will be described as an example.

First, the power from the power source that is supplied via the power receiving terminal 21 is received after being limited to a predetermined current value by the input current limiting circuit 11. Then, the power is supplied from the input current limiting circuit 11 to the boosting converter 12.

Next, the voltage of the supplied power is boosted to a target voltage by the boosting converter 12. This target voltage is set on the basis of the current battery voltage of the secondary battery 22 notified to the boosting circuit 13 by the control circuit 16. The target voltage is a value that is equal to or greater than the current battery voltage of the secondary battery 22 and equal to or less than the multiplication voltage value, as illustrated by the broken line in FIG. 5. Then, the boosting converter 12 supplies the boosted power to the power wiring 14.

In a case where the secondary battery 22 is formed by two lithium-on secondary batteries connected together in series, the target voltage is a value that is equal to or greater than the current voltage of the secondary battery 22, and is equal to or less than a value (multiplication voltage value) obtained by multiplying the maximum voltage of 4.2 V per cell of the lithium-ion secondary batteries by two, which is the number in the series, i.e., “4.2 V×2=8.4 V”. In the description below, the voltage that has been boosted to a target voltage that is a value both equal to or greater than the current battery voltage of the secondary battery 22 and equal to or less than the multiplication voltage value will be referred to as “battery voltage+α”. α is the difference between the voltage of the secondary battery 22 and the target voltage.

In a case where the output voltage of the boosting converter 12 is equal to the voltage of the power wiring 14, and the target voltage of the boosting circuit 13 is higher than the voltage of the secondary battery 22, a reverse bias is applied to the switching circuit 15 such that power will not be supplied from the secondary battery 22 side to the power wiring 14. At the same time, power will also not be supplied from the power wiring 14 to the secondary battery 22, i.e., a charging operation to the secondary battery 22 will not be performed. Therefore, the power output from the boosting converter 12 is supplied to the step-down circuit 18 via the power wiring 14.

Also, power is supplied to the load 23 after being stepped down by the step-down circuit 18 to the voltage required by the load 23. As described above, the target voltage of the boosting converter 12 is suppressed to a value equal to or less than the multiplication voltage value. Therefore, power loss caused by boosting the voltage and power loss caused by stepping down the voltage can be reduced compared to a case where the voltage is boosted to 8.4 V which is two times the maximum voltage of 4.2 V per cell of the lithium-ion secondary batteries.

As a result, the sum of power loss caused by boosting the voltage and power loss caused by stepping down the voltage is able to be inhibited from becoming significantly larger than it is in a case where power is supplied directly from the secondary battery 22, so it is possible to inhibit the temperature inside the power supply device 10 from increasing due to the loss that occurs being converted into heat.

Also, in a case where the power consumption of the load 23 increases, a large voltage fluctuation between the target voltage and the battery voltage occurs in a conventional device. However, in the present embodiment, the effect on the load 23 downstream can be minimized by suppressing that voltage fluctuation to only the a part of the “battery voltage+α”, as illustrated by the broken line in FIG. 5.

The present technology boosts the voltage of the supplied power to the target voltage, such that the voltage of the supplied power is slightly higher than the voltage of the secondary battery 22. As a result, power loss that additionally occurs in a case where the load 23 is operating with only power from the secondary battery 22 can be suppressed to only boost loss when the voltage is boosted to the target voltage. Therefore, the power loss that occurs can be reduced significantly compared to conventional technology.

This will be described using a specific value taking as an example a case where 5.0 V power is supplied from the USB Vbus as the power from the power source. Note that the secondary battery 22 is formed by connecting two lithium-ion secondary batteries together in series.

As described above, the lithium-ion secondary batteries have a discharge characteristic per cell in which a rated voltage of around 3.7 V is maintained for most of the discharge period, as illustrated in FIG. 2. The two serially-connected lithium-ion secondary batteries have a characteristic in which the voltage is doubled, and thus similarly have a characteristic in which the voltage is maintained at a rated voltage of around 7.4 V.

In a case where α (the difference between the voltage of the secondary battery 22 and the target voltage) of the “battery voltage+α” that is the target voltage is set at 50 mV, the voltage is boosted from 5.0 V to 7.45 V by the boosting circuit 13, and then stepped down by the step-down circuit 18 and supplied to the load 23. On the other hand, with the conventional technology, the voltage is boosted from 5.0 V to 8.4 V by the boosting circuit 13, and then stepped down by the step-down circuit 18, and the power is supplied to the load 23. Therefore, in the present embodiment, power loss caused by boosting the voltage and stepping down the voltage is reduced by 0.95 V compared to the method of the conventional technology.

Moreover, in the present technology, an increase in output current for power supply can also be realized. For example, in a case where power is supplied from a direct-current power supply input such as the USB Vbus, the current rating stipulated by the USB standard must be observed. For example, it is possible to receive a supply of power that complies with the USB standard by multiplying the maximum input current limit of 1.5 A by an input voltage of 5 V. In this case, power of “5 V×1.5 A=7.5 W” at most can be received. In a case where this power is supplied to the step-down circuit 18 through the boosting circuit 13, the current value output from the boosting circuit 13 will increase the lower the target voltage of the boosting circuit 13 is.

For example, in a case where the input power was 7.5 W, if the target voltage is 8.4 V and the boosting efficiency of the boosting circuit 13 is 84%, the output current value will be “7.5 W×0.84/8.4 V=0.75 A”. In contrast, in a case where the target voltage is 7.4 V, if the boosting efficiency is similarly 84%, the output current value will be “7.5 W×0.84/7.4 V=0.85 A”, so the output current value can be made to increase. The boosting efficiency improves the smaller the difference between the input voltage and the output voltage is, so the output current value can be increased in this way. As a result, in a case where there is a circuit that requires a current in the load 23, for example, the load 23 such as an electric motor or an actuator, there is able to be some leeway in the operation of these loads 23 due to the increase in the output current value.

In a conventional device, the secondary battery has internal impedance, so a voltage drop occurs when current is supplied from the secondary battery to the outside. When the voltage of the secondary battery becomes equal to or less than the minimum operating voltage of the device, the device stops operating. To deal with such a voltage drop, it is necessary to set the minimum operating voltage to the voltage of the secondary battery so that it will not fall below the allowable voltage range of the step-down circuit that supplies power to the load. In a case where there is a load that requires current, a higher minimum operating voltage must be set taking the current required by these loads into account.

With regards to this, with the boosting circuit 13 of the power supply device 10 according to the present technology, even if the voltage of the secondary battery 22 is close to the minimum operating voltage, the current that can be supplied from the boosting circuit 13 increases so the minimum operating voltage can be set lower.

Also, because the current that can be supplied from the boosting circuit 13 increases, the current supplied from the secondary battery 22 can be reduced, so a drop in the voltage of the secondary battery 22 can be suppressed.

[1-2-2. Supplying Power from Power Source to Secondary Battery]

Next, the charging of the secondary battery 22 will be described. In a case where the voltage of supplied power is boosted to a higher target voltage than the voltage of the secondary battery 22 by the boosting circuit 13, a reverse bias is applied to the switching circuit 15 such that power will not be supplied from the secondary battery 22 to the power wiring 14.

In a case where the control circuit 16 has detected that the voltage of the secondary battery 22 has become lower than a predetermined threshold value, the control circuit 16 charges the secondary battery 22 by causing the initial charging circuit 17 to operate and supplying power from the boosting circuit 13 to the secondary battery 22.

In order to realize safe charging of the secondary battery 22, initial charging is performed by constant current charging in which the charging current is kept low, in a case where the voltage of the secondary battery 22 is equal to or less than a predetermined voltage, as illustrated in FIG. 3. Then, in a case where the voltage of the secondary battery 22 exceeds the predetermined threshold value, the charging current limitation value is made to change from the initial charging current value to the fast charging current value in order to make a transition from initial charging to fast charging. The fast charging current value is a value that is larger than the initial charging current value.

In order to perform fast charging, a larger charging current than the initial charging current can be supplied to the secondary battery 22 by appropriately controlling the switching circuit 15.

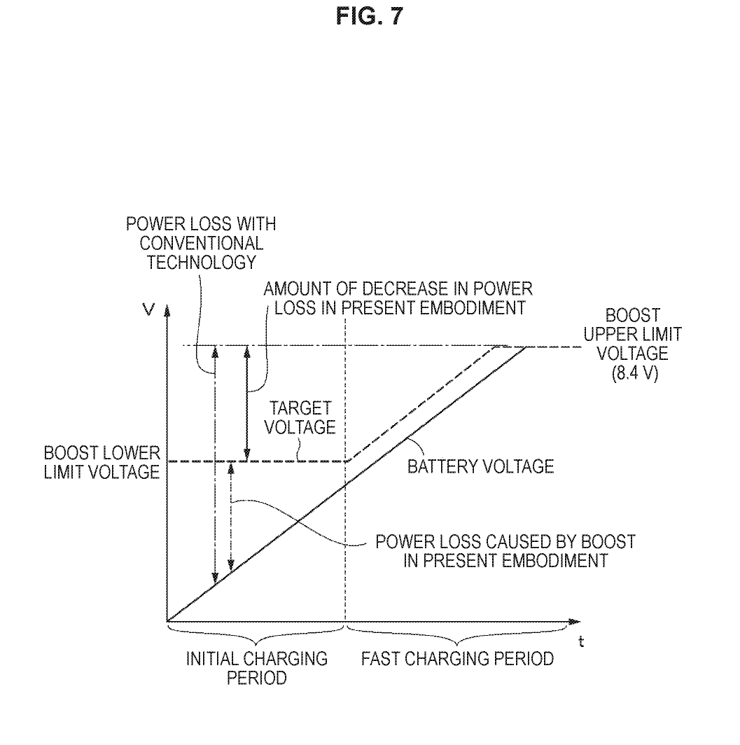

However, if initial charging is performed by the initial charging circuit 17 (constant current circuit) in a case where the target voltage of the boosting circuit 13 is 8.4 V, which is two times the maximum voltage of 4.2 V per cell of the lithium-ion secondary batteries as in the conventional technology, power loss caused by stepping down the voltage will occur, as illustrated by the alternate long and short dash line in FIG. 7. This power loss is at its maximum at “(8.4 V−0 V . . . initial charging current value”. For example, in a case where the initial charging current is 100 mA, a power loss of 0.84 W occurs just in the initial charging circuit 17 (constant current circuit). This all becomes heat within the initial charging circuit 17 (constant current circuit), so a large loss occurs just to flow the current of 100 mA.

Also, generally with a battery having a large capacity, the initial charging period is shortened by increasing the initial charging current. However, if the initial charging current cannot be increased due to the power loss caused by stepping down the voltage as described above, the initial charging current cannot be increased to the optimum value, even in a case where it is desired to introduce a larger capacity secondary battery 22, and as a result, the initial charging period becomes longer, so the overall charging time becomes longer.

Therefore, when charging the secondary battery 22, a boost lower limit voltage that is the lower limit of the target voltage, as illustrated by the broken line in FIG. 7, is set in order to reduce the power loss in the initial charging circuit 17 while stably boosting the voltage in the boosting circuit 13.

As illustrated in FIG. 7, the target voltage by the boosting circuit 13 is limited to the boost lower limit voltage until the voltage of the secondary battery 22 reaches a predetermined value, which is the initial charging period. Then, when the voltage of the secondary battery 22 exceeds the predetermined value and reaches the fast charging period, the target voltage is raised in proportion to the rise in the battery voltage, and is eventually made to be boosted to a boost upper limit voltage that is a value equal to the voltage when the secondary battery 22 is fully charged.

As a result, power loss caused by the difference between the battery voltage and the target voltage is less compared to a case where power from the power source is boosted from the start of charging to a value equal to the battery voltage when the secondary battery 22 is fully charged and then supplied to the secondary battery 22, as illustrated in FIG. 7.

Setting the boost lower limit voltage enables power loss that occurs in the initial charging circuit 17 to be suppressed by an amount corresponding to “(voltage when secondary battery 22 is fully charged—boost lower limit voltage . . . initial charging current”. As a result, that power loss can be distributed by increasing the initial charging current. Therefore, the charging time can be shortened because the initial charging current can be increased while maintaining the power loss amount at the same level as that with a conventional method.

The power loss amount is “(voltage when secondary battery 22 is fully charged —boost lower limit voltage . . . initial charging current”, so assuming the same amount of power loss can be tolerated, the initial charging current will be (boost upper limit voltage/boost lower limit voltage) times.

To illustrate this using a specific value, in a case where the initial charging current is 100 mA and the fully charged voltage of the secondary battery 22 is 8.4 V, the power loss amount will be “(8.4−0)×0.1=0.84 W” at most. Assuming the “battery voltage+α”, which is the target voltage of the boosting circuit 13, is 6 V and the same amount of power loss as 0.84 W can be tolerated, the charging current will be “(8.4/6.0)×0.1=0.14”, so the initial charging current can be made to increase up to 140 mA. As a result, the initial charging time can be made 0.7 times shorter than in a case where the initial charging current is 100 mA, so the initial charging time can be the same as that in a case of charging the secondary battery 22 having 1.4 times the capacity.

When the initial charging current is able to be increased in this way, the power supply device 10 can be applied not only to charging a single large capacity secondary battery, but also to a case where a plurality of secondary batteries are charged in parallel by branching off from a single direct-current power supply input terminal. Because the initial charging current can be maximized for each of the plurality of secondary batteries, it is possible to realize a plurality of battery chargers with better characteristics.

Regarding the boost lower limit voltage, a plurality of values may be provided in advance, and the value closest to the voltage of the secondary battery 22, from among those values, may be selected and set. As a result, in a case where the voltage of the secondary battery 22 is extremely low, the lower limit value of the target voltage is also set low, so the power loss in the initial charging circuit 17 can also be reduced. Also, in a case where the voltage of the secondary battery 22 has risen, charging according to the charging characteristics of the secondary battery 22 can also be performed by raising the target voltage of the boosting circuit 13 as well.

With a charging method in which the initial charging circuit 17 and the circuit that performs fast charging are different, the change in current between initial charging and fast charging is large, so it is necessary to realize stable switching of the charging mode. If switching of the charging mode is unstable, it may cause an abnormal state, e.g., it may cause charging to stop unexpectedly.

On the other hand, with the present technology, stable switching of the charging mode can be realized by simultaneously using initial charging and fast charging when switching from initial charging to fast charging. Note that in order to realize such an operation, it is necessary to give the initial charging circuit 17 a reverse current prevention characteristic with a reverse bias.

Also, even in a case where the secondary battery 22 is not connected to the power supply device 10 and the boosting circuit 13 is made to operate to detect connection of the secondary battery 22, power loss caused by boosting the voltage can be reduced by setting the boost lower limit voltage and then performing a boost operation. As a result, it is possible to reduce power consumption in a standby state, such as when the secondary battery 22 is waiting to be connected, so it is possible to meet the tightener energy conservation regulations being implemented in various countries nowadays.

[1-2-3. Supplying Power from Secondary Battery to Load]

Next, supplying power from the secondary battery 22 to the load 23 will be described. In the power supply device 10 of the present embodiment, the target voltage of the boosting converter 12 is set to become higher than the voltage of the secondary battery 22. Therefore, the output voltage of the boosting converter 12, i.e., the voltage of the power wiring 14, is normally guaranteed to always be higher than the voltage of the secondary battery 22. From this relationship, the switching circuit 15 formed by an ideal diode circuit will not supply power from the secondary battery 22 to the power wiring 14 unless the power consumed by the load 23 exceeds the power supplied by the boosting circuit 13. Therefore, only the power always supplied by the boosting circuit 13 will be supplied to the load 23, so the power of the secondary battery 22 will not be consumed by the load 23.

However, if the power consumption of the load 23 exceeds the power supplied from the boosting circuit 13, the voltage of the power wiring 14 will drop sharply so the load 23 will no longer be able to be made to operate normally. Therefore, in a case where the power consumption of the load 23 exceeds the power supplied from the boosting circuit 13, the control circuit 16 controls the switching circuit 15 to set a forward bias and supplies power from the secondary battery 22 to the load 23 via the switching circuit 15 and the power wiring 14. As a result, the voltage of the power wiring 14 can be supported so as not to drop significantly lower than the voltage of the secondary battery 22.

Because power is supplied from the secondary battery 22 to the load 23 through the power wiring 14 immediately after the forward bias state of the switching circuit 15 is established, power can be continuously supplied to the load 23. Therefore, unintended shutdown of the load 23 due to the operation of the load 23 being unable to be maintained as a result of insufficient power will not occur. Furthermore, if the power consumption of the load 23 is reduced, the voltage of the boosting circuit 13 will recover, and the power wiring 14 and the secondary battery 22 will be separated by the switching circuit 15 reverse biasing, so power will stop being supplied from the secondary battery 22. As a result, it is possible to realize the power supply device 10 capable of effectively utilizing power from the secondary battery 22 without consuming the power of the secondary battery 22 except when necessary.

In the present embodiment, an additional effect can be obtained by setting the target voltage in the boosting circuit 13 to a value that is equal to or greater than the voltage of the secondary battery 22, and the equal to or less than a value (multiplication voltage value) obtained by multiplying the maximum voltage per cell of secondary batteries connected in series to constitute the secondary battery 22, and the number of those secondary batteries connected in series.

This is an effect of suppressing voltage fluctuation in the power wiring 14 that occurs due to a potential difference between the target voltage of the boosting circuit 13 and the voltage of the secondary battery 22. In a case where the target voltage is a fixed multiplication voltage value, the voltage of the power wiring 14 maintains the multiplication voltage value in a case where the power consumption of the load 23 is equal to or less than the supply capability of the boosting circuit 13. However, when the power consumption of the load 23 becomes equal to or greater than the supply capability of the boosting circuit 13, a phenomenon in which the voltage drops to the battery voltage occurs. This voltage fluctuation may affect the operation of the load 23.

For example, the output voltage of the step-down circuit 18 will be affected in a case where the voltage fluctuation becomes larger than the voltage fluctuation allowed by the input voltage fluctuation characteristic of the step-down circuit 18 connected to the downstream side of the power wiring 14. In contrast, with the present technology, this voltage fluctuation can be suppressed to the amount of a.

In the case of a lithium-ion secondary battery having a rated voltage of 7.4 V, for example, when the voltage of the secondary battery 22 is 7.4 V, a voltage fluctuation of “8.4 V−7.4 V=1.0 V” will end up occurring in accordance with the power consumption of the load 23 with a conventional method. On the other hand, if the target voltage is equal to or less than the multiplication voltage value, and the battery voltage is +50 mV, for example, the voltage fluctuation will be 0.05 V, so the fluctuation amount can be suppressed by −34 dB, and as a result, the effect of the fluctuation is almost negligible. Therefore, even if the power consumption of the load 23 exceeds the supply power of the boosting circuit 13 such that a voltage fluctuation occurs, the effect on the load 23 can be reduced.

Note that in a case where priority is given to reducing power loss in a case where it is possible to set a of the target voltage “voltage of secondary battery 22+α” within a range from an approximate value of 40 mV to an approximate value of 400 mV, α may be set to 40 mV or an approximate value of 40 mV and tracking may be performed using an instantaneous value.

Also, in a case of prioritizing supply capability stability of the power supply device 10, the voltage of the power wiring 14 can be more stably maintained at a constant value if a is set to 400 mV or an approximate value of 400 mV. The 40 mV and 400 mV are values obtained by testing.

By applying the present technology, both power loss caused by boosting the voltage and power loss caused by stepping down the voltage in order to supply power to the load 23 can be simultaneously reduced in a system that supplies power to the load 23 from a direct-current power supply output such as a USB Vbus, for example. As a result, power can be supplied while suppressing heat generation.

Because loss is reduced particularly in a case where the battery voltage is low, more power can be supplied. Also, the overall charging time can be reduced by shortening the charging time with the initial charging circuit 17.

In a case where the battery voltage is low, the current supplied from the secondary battery 22 usually ends up increasing for the load 23 requiring the same power, but because the current supplied from the power source can be increased, the current supplied from the secondary battery 22 can be reduced so the performance of the secondary battery 22 can be maximized Therefore, the margin against the end voltage can be increased.

In particular, when operating near the rated voltage with the longest operating time when using the lithium-ion secondary batteries, the effect of the present technology is maintained for an extended period of time because the period of time during which power is efficiently supplied is longer.

Even if the power required by the load 23 exceeds the supply capability of the boosting circuit 13, the voltage supplied to the step-down circuit 18 is close to the battery voltage so the voltage fluctuation range becomes smaller. As a result, the effect of the voltage fluctuation on other circuits is able to be suppressed. Also, the initial charging current to the secondary battery 22 can be increased, so the initial charging time can be shortened. Furthermore, in a charger characterized in that a plurality of batteries are charged in parallel, the parallel batteries are equivalent to a double capacity battery, so the initial charging current can be increased similar to when charging the large capacity secondary battery 22, even in a case where the plurality of batteries are charged in parallel.

### 2. Modified Example

Heretofore, an embodiment of the present technology has been described in detail, but the present technology is not limited to this embodiment; various modifications based on the technical concept of the present technology are possible.

In the embodiment, a description is given using an example in which the secondary battery 22 is formed by connecting two lithium-ion secondary batteries together in series, but only one lithium-ion secondary battery may be used or three or more lithium-ion secondary batteries may be connected together. The secondary battery 22 is not limited to being formed using a lithium-ion secondary battery, and may instead be formed using a lithium-ion polymer secondary battery, a sodium-sulfur secondary battery, or a sodium-ion secondary battery or the like.

The present technology can be applied to any device having a battery voltage higher than the voltage of the power to be supplied, i.e., any device requiring the voltage to be boosted in order to supply power.

Note that the step-down circuit 18 need not be included in the power supply device 10; instead, the system on the load 23 side may be provided with a step-down circuit.

For example, in a case where an electronic device such as a tablet terminal, a notebook computer, a camera, a portable speaker or the like employs a battery configuration in which two or more secondary batteries are connected, the present technology can be applied to these electronic devices. Also, even if there is only one secondary battery, in a case where that one secondary battery has a battery voltage comparable to a case where two or more secondary batteries are connected together, the present technology can be applied to these electronic devices.

Additionally, the present technology may also be configured as below.

(1)

A power supply device including: a boosting circuit that boosts power supplied from a power source to a target voltage based on a voltage of a secondary battery capable of supplying power to a load, and supplies the boosted power to the load.

(2)

The power supply device according to (1), in which

the target voltage is a value equal to or greater than a current voltage value of the secondary battery.

(3)

The power supply device according to (1) or (2), in which

the secondary battery is formed by connecting two or more batteries together in series, and

the target voltage is a value equal to or less than a multiplication value of a maximum voltage of the secondary battery and a number of the secondary batteries connected together in series.

(4)

The power supply device according to any of (1) to (3), further including:

a control unit that acquires a current voltage value of the secondary battery and notifies the boosting circuit of the acquired voltage value.

(5)

The power supply device according to (4), in which

the boosting circuit boosts the power to the target voltage set on a basis of an instantaneous value of the voltage value of the secondary battery.

(6)

The power supply device according to (4), in which

the boosting circuit boosts the power to a target voltage set on a basis of a time average value of the voltage value of the secondary battery.

(7)

The power supply device according to any of (1) to (6), in which

an increase amount of the target voltage from the voltage of the secondary battery is within a range from an approximate value of 40 mV to an approximate value of 400 mV.

(8)

The power supply device according to any of (1) to (7), further including:

a charging circuit that charges the secondary battery with power supplied from the boosting circuit.

(9)

The power supply device according to (8), in which

the charging circuit charges the secondary battery by constant current charging.

(10)

The power supply device according to (8) or (9), in which

the secondary battery starts to be charged with a first current value that is a constant value, and after the voltage of the secondary battery reaches a predetermined value, the secondary battery is charged with a second current value that is a value larger than the first current value.

(11)

The power supply device according to any of (8) to (10), in which

in charging the secondary battery with the charging circuit, a lower limit voltage of a boost by the boosting circuit is set, and charging is performed at a voltage equal to or greater than the lower limit voltage.

(12)

The power supply device according to (11), in which

the lower limit voltage of the boost is a value equal to or greater than the voltage of the secondary battery during a period when charging is performed at the first current value.

(13)

The power supply device according to any of (1) to (12), further including:

a step-down circuit that steps down power boosted by the boosting circuit to a voltage required by the load and supplies the stepped-down power to the load.

(14)

The power supply device according to any of (1) to (13), further including:

a switching circuit that switches between supplying power supplied from the boosting circuit to the secondary battery, and supplying power from the secondary battery to the load.

(15)

The power supply device according to any of (1) to (14), in which

the boosting circuit acquires information regarding a target voltage that is based on the voltage of the secondary battery.

(16)

The power supply device according to any of (1) to (15), including:

a power receiving terminal that conforms to USB standards and supplies power from the power source to the boosting circuit.

(17)

A power supply method including:

boosting power supplied from a power source to a target voltage based on a voltage of a secondary battery capable of supplying power to a load, and supplying the boosted power to the load.

### REFERENCE SIGNS LIST

10 power supply device.
13 boosting circuit
15 switching circuit
16 control unit
17 initial charging circuit
18 step-down circuit
23 load
22 secondary battery

1. A power supply device comprising:
a boosting circuit that boosts power supplied from a power source to a target voltage based on a voltage of a secondary battery capable of supplying power to a load, and supplies the boosted power to the load.

2. The power supply device according to claim 1, wherein
the target voltage is a value equal to or greater than a current voltage value of the secondary battery.

3. The power supply device according to claim 2, wherein
the secondary battery is formed by connecting two or more batteries together in series, and
the target voltage is a value equal to or less than a multiplication value of a maximum voltage of the secondary battery and a number of the secondary batteries connected together in series.

4. The power supply device according to claim 1, further comprising:
a control unit that acquires a current voltage value of the secondary battery and notifies the boosting circuit of the acquired voltage value.

5. The power supply device according to claim 4, wherein
the boosting circuit boosts the power to the target voltage set on a basis of an instantaneous value of the voltage value of the secondary battery.

6. The power supply device according to claim 4, wherein
the boosting circuit boosts the power to a target voltage set on a basis of a time average value of the voltage value of the secondary battery.

7. The power supply device according to claim 1, wherein
an increase amount of the target voltage from the voltage of the secondary battery is within a range from an approximate value of 40 mV to an approximate value of 400 mV.

8. The power supply device according to claim 1, further comprising:
a charging circuit that charges the secondary battery with power supplied from the boosting circuit.

9. The power supply device according to claim 8, wherein
the charging circuit charges the secondary battery by constant current charging.

10. The power supply device according to claim 9, wherein
the secondary battery starts to be charged with a first current value that is a constant value, and after the voltage of the secondary battery reaches a predetermined value, the secondary battery is charged with a second current value that is a value larger than the first current value.

11. The power supply device according to claim 10, wherein
in charging the secondary battery with the charging circuit, a lower limit voltage of a boost by the boosting circuit is set, and charging is performed at a voltage equal to or greater than the lower limit voltage.

12. The power supply device according to claim 11, wherein
the lower limit voltage of the boost is a value equal to or greater than the voltage of the secondary battery during a period when charging is performed at the first current value.

13. The power supply device according to claim 1, further comprising:
a step-down circuit that steps down power boosted by the boosting circuit to a voltage required by the load and supplies the stepped-down power to the load.

14. The power supply device according to claim 1, further comprising:
a switching circuit that switches between supplying power supplied from the boosting circuit to the secondary battery, and supplying power from the secondary battery to the load.

15. The power supply device according to claim 1, wherein
the boosting circuit acquires information regarding a target voltage that is based on the voltage of the secondary battery.

16. The power supply device according to claim 1, comprising:
a power receiving terminal that conforms to USB standards and supplies power from the power source to the boosting circuit.

17. A power supply method comprising:
boosting power supplied from a power source to a target voltage based on a voltage of a secondary battery capable of supplying power to a load, and supplying the boosted power to the load.
